(19) United States
(12) Patent Application Publication
(10) Pub. No.: US 2005/0223564 A1
(43) Pub. Date: Oct. 13, 2005

(54) Safety knife and pouch for safety knife

(76) Inventor: Anders Hanson, Hollviken (SE)

Correspondence Address: Steven S. Payne, 8027 ILIFF Drive, Dunn Loring, VA, 22027, US

(21) Appl. No.: 10/812,997

(22) Filed: Mar. 31, 2004

(51) Int. Cl. B26B 3/00; A63C 5/00

(52) U.S. Cl. 30/172

(57) ABSTRACT

A safety knife for cutting lines or straps, comprising a handle, a base arm, an extension arm and a cutting arrangement, where the extension arm curves from the base arm to establish an opening between the base arm and the extension arm, and where the cutting arrangement is arranged in the opening, wherein the base arm is arranged with an angle between a longitudinal direction of the base arm and a longitudinal direction of the handle.

### BACKGROUND OF THE INVENTION

1. Field of the Invention

The present invention relates to a safety knife, and more particularly to a safety knife to be used at parachuting and kite surfing, and a pouch for such a safety knife.

2. Description of Prior Art

Safety knives are generally intended for extricating someone who is unwillingly being trapped or otherwise confined. Accordingly, safety/rescue knives are generally used to cut straps, lines, or sheets of material that entraps a person in situations that can be life threatening.

In e.g. parachuting, it is vital for a user of the parachute to be released from the lines of a first parachute, if the first parachute does not release itself correctly, enabling the user to release a second parachute. The parachute jumper to be released from the lines of the parachute uses a safety knife.

Also in kite surfing there is a need for a safety knife to enable the surfer to release himself from the kite if he should be entrapped by the lines of the kite for some reason in a potentially hazardous situation.

An example of a safety knife is shown in U.S. Pat. No. 5,829,321, having a handle with a base arm which extends from the handle. Further, an extension arm extends from the base arm and curves from the base arm to establish an opening between the base arm and the extension arm. In the opening two cutting elements are arranged to form a V-shape, the cutting elements overlapping each other in the inner part of the V-shape. An opening formed by the cutting elements is fairly small to effectively gather the lines or straps that are to be cut.

The handle, the base arm and the extension arm are all made of plastics, molded in two halves which are joined together by means of screws. The cutting elements are formed by blades, which are replaceably arranged in the two halves. The blades of the safety knife can be broken or dulled during the use thereof. It should therefore be possible to replace them. A spare blade may be arranged in a storage compartment in the interior of the knife as shown in U.S. Pat. No. 5,829,321.

A grip part of the handle is provided at one end of the handle opposite the blades to avoid that a user damages his finger(s) on the lines or the straps when using the knife. There is a need for a safety distance between the grip part and the cutting elements.

A problem with the above mentioned prior art safety knife is the length of the knife, which makes it difficult for the user to wear the knife and sometimes makes it impossible to place the knife in a pilot dress and even more difficult for a kite surfer to wear the knife. One solution of this problem has been to saw off a part of the handle, but this is not recommended because the risk to be damaged by the lines or the straps increases substantially.

Another problem with safety knives is the method of carrying the knife, which should be easily available in a hazardous situation and still should safely carried without the risk of dropping the knife while practicing parachuting or kite surfing. It is earlier known to have a pouch made of Cordura® or canvas for holding a safety knife. The pouch can be attached to the dress of the user by sewing or in another similar way. However, one problem with the pouch made of Cordura® is that the Cordura® material is sewed together to form the pouch and the hems of the sewing hinders the safety knife when it is to be pulled out of the pouch, especially if it is pulled out obliquely.

In another application the safety knife is stored inside a collar of a pilot dress together with inflatable floating bodies. When oxygen capsules are actuated to inflate the floating bodies the collar splits to allow the floating bodies to be inflated and the safety knife is made available to the user. The base arm and the extension arm of the safety knife are covered by an elastic sock or sleeve protecting the floating bodies from the cutting elements. The elastic sock is attached to an end part by sewing to the collar. Additionally, a couple of straps may also be used for holding the safety knife in position on the collar.

### SUMMARY OF THE INVENTION

It is an object of the present invention to provide a safety knife that is shorter than prior art safety knives without increasing the risk that the fingers hinder the lines or straps of the parachute or kite to enter between the blades.

According to a first preferred embodiment of the claimed invention this object is achieved by a safety knife comprising a handle, a base arm and an extension arm, where at least one cutting element is provided in an opening between the base arm and the extension arm, and where the base arm forms an angle in respect of the handle.

Another object of the present invention is to provide a solution to how a safety knife can be worn and still be easily available to the user in a hazardous situation.

According to a preferred embodiment of the claimed invention this object is achieved by a pouch for safety knives having an device for attaching the pouch to a user and an device for safely retaining the knife in the pouch during miscellaneous activities, where the pouch is configured to ensure quick access of the knife without problems in a hazardous situation.

Further features of the invention are defined in the dependent claims.

The angle between the longitudinal direction of the base arm and the longitudinal direction of the handle enables the user to cut lines or straps without the risk that his fingers hinder the lines or the straps to enter between the blades when using the knife. Furthermore, the angle reduces the need for a safety distance between the grip part and the cutting elements, thus the safety knife can be made shorter and will be easier to carry and attach to the dress of the user.

It should be emphasized that the term “comprises/comprising” when used in this specification is used to specify the presence of stated features, integers, steps or components but does not preclude the presence or addition of one or more other features, integers, steps, components or groups thereof.

### BRIEF DESCRIPTION OF THE DRAWINGS

The invention will be explained more in detail below, by way of example, in connection with preferred embodiments and with reference to the drawings, in which:

FIG. 1 is a side view of a first embodiment of a safety knife according to the present invention,

FIG. 2 is a side view of a second embodiment of a safety knife according to the present invention,

FIG. 3 is a side view of a third embodiment of a safety knife according to the present invention,

FIG. 4 is a side view of a fourth embodiment of a safety knife according to the present invention, and

FIGS. 5a and 5b are schematic perspective views of a pouch for a safety knife according to the present invention.

### DESCRIPTION OF PREFERRED EMBODIMENTS

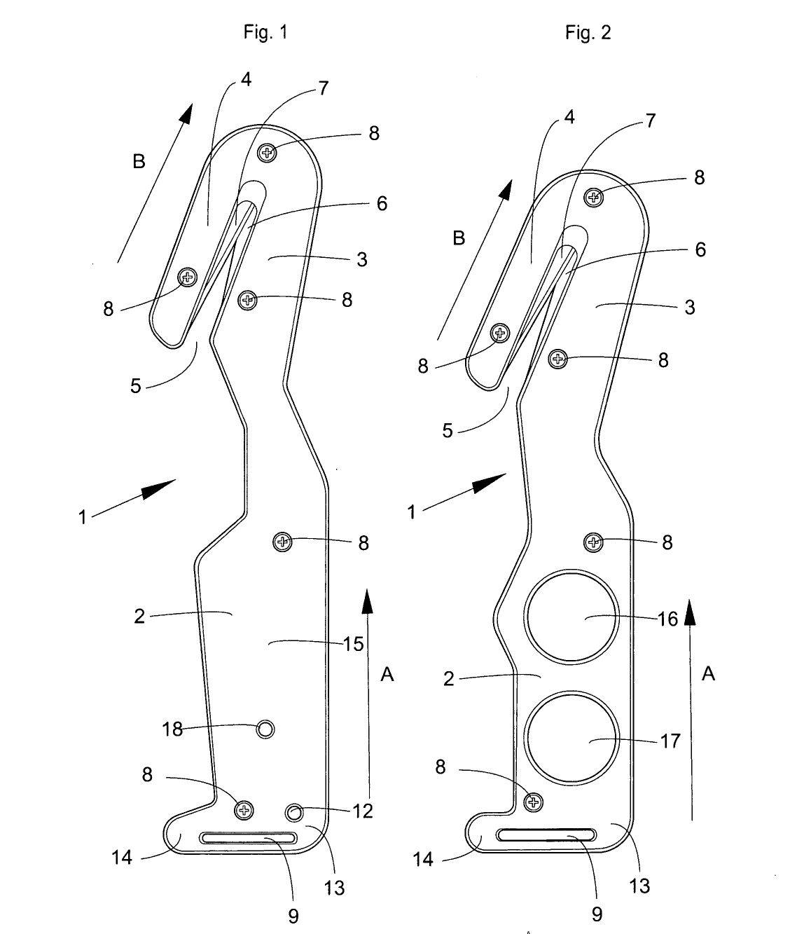

The safety knife 1 disclosed in FIG. 1 includes a handle 2, a base arm 3 and an extension arm 4. The base arm 3 extends from the handle 2, and the longitudinal direction B of the base arm 3 is angled in relation to the longitudinal direction A of the handle 2. Further, the extension arm 4 extends from the base arm 3 and has a longitudinal direction substantially parallel to the longitudinal direction B of the base arm 3. The extension arm 4 curves from the base arm 3 to establish an opening 5 between the base arm 3 and the extension arm 4. In the opening 5 two cutting elements are formed blades 6, 7 arranged to form a V-shape, the blades 6, 7 overlapping each other in the inner part of the V-shape. The opening 5 giving access to the blades 6, 7 is fairly small to effectively gather the lines or straps that are to be cut.

The handle 2, base arm 3 and the extension arm 4 are molded in two halves (not shown) which are joined together. The blades 6, 7 are replaceably received by recesses (not shown) in the two halves. At the other end of the handle 2 as seen from the base arm 3 a slot 9 is provided for attachment of a strap (not shown) for holding the knife 1 and a fastening device for attaching the strap to a knife pouch or the like. The fastening device may be a snap fastener or a Velcro© type fastener. An aperture 12 is also arranged in the handle 2 for attaching a safety cord (not shown) that is connected to the safety knife at one end and attached to the user, the dress of the user, or other equipment of the user at the other end to secure that the safety knife will not be lost if the user should drop the knife.

Inside the handle 2 a compartment (only partly visible through a hole 18 in the handle 2) can also be arranged for storage of a spare blade or blades to enable a user to replace one or both of the blades 6, 7 if broken or dulled during the use thereof. The compartment is accessible by removing the joint holding the two halves of the safety knife 1 together, and separating the two halves from each other. The compartment has substantially the form of the blades and preferably should be able to contain at least two blades 6, 7.

Close to the end 13 of the handle 2 a grip portion 15 and a projection 14 are arranged. The grip portion 15 of the handle 2 is broader than in the part of handle 2 adjacent to the base arm 3. The grip portion 15 is arranged to enabling the user to grasp the safety knife 1 in a good and secure manner when he is going to use the safety knife 1. The projection 14 provides an end portion of the handle 2 that gives the user a better hold of the handle 2 in that the risk for dropping the knife is reduced.

The second embodiment of the safety knife according to the present invention disclosed in FIG. 2 differs from the first embodiment in that the handle 2 is provided with apertures 16, 17, which can be used as an alternative of holding the safety knife 1. The user can insert fingers in the apertures 16, 17 as an alternative way to grasp around the handle 2. Another holding alternative is to insert one finger in apertures 17 and place another finger on the projection 14.

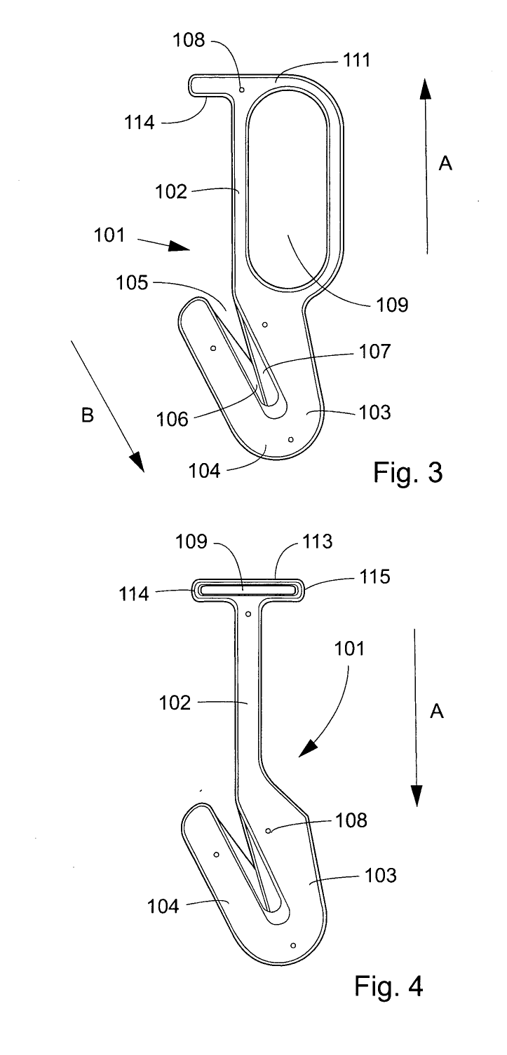

The third embodiment of the safety knife according to the present invention disclosed in FIG. 3 is substantially shorter than the previous embodiments. The safety knife 101 includes a handle 102, a base arm 103 and an extension arm 104. The base arm 103 extends from the handle 102, and the longitudinal direction B of the base arm 103 is angled in relation to the longitudinal direction A of the handle 102. Further, the extension arm 104 extends from the base arm 103 and has a longitudinal direction substantially parallel to the longitudinal direction B of the base arm 103. The extension arm 104 curves from the base arm 103 to establish an opening 105 between the base arm 103 and the extension arm 104. In the opening 105 two blades 106, 107 are arranged to form a V-shape. The blades 106, 107 overlap each other in the inner part of the V-shape. The opening 105 between the blades 106, 107 is fairly small to effectively gather the lines or straps that are to be cut.

In the handle 102 an elongated aperture 109 is arranged extending along the longitudinal direction A of the handle 102. A strap (not shown) can be attached to the handle 102 at one end 111 of the aperture 109. The strap can be used for holding the knife 101 and a fastening device for attaching the strap to a knife pouch or the like.

The blades 106, 107 are arranged in the molded material as described in connection with the first and second embodiments, and the safety knife 101 is also otherwise similar to the first and second embodiments.

The elongated aperture 109 is used for holding the safety knife 101. The user inserts the fingers into the elongated aperture 109 instead of grasping around the handle 102 as in the first and second embodiments. Another holding alternative is to insert one finger in the elongated aperture 109 and to place another finger on a projection 114.

The fourth embodiment of the safety knife according to the present invention disclosed in FIG. 4 differs from the third embodiment in that the handle 102 is not provided with an elongated aperture but is instead provided with two projections 114, 115 extending from an end part 113 of the handle 102 in opposite directions, substantially perpendicular to the longitudinal direction A of the handle 102. In the end part 113 of the handle 102 an slot 109 is provided for attaching a strap (not shown) for holding the knife 101 and a fastening device for attaching the strap to a knife pouch or the like.

Instead of providing a slot in the end part 113 a float (not shown) can be arranged inside the end part 113 enabling the safety knife 101 to float if it is dropped into water. One or several floats can also be arranged on the strap attached in the slot 109.

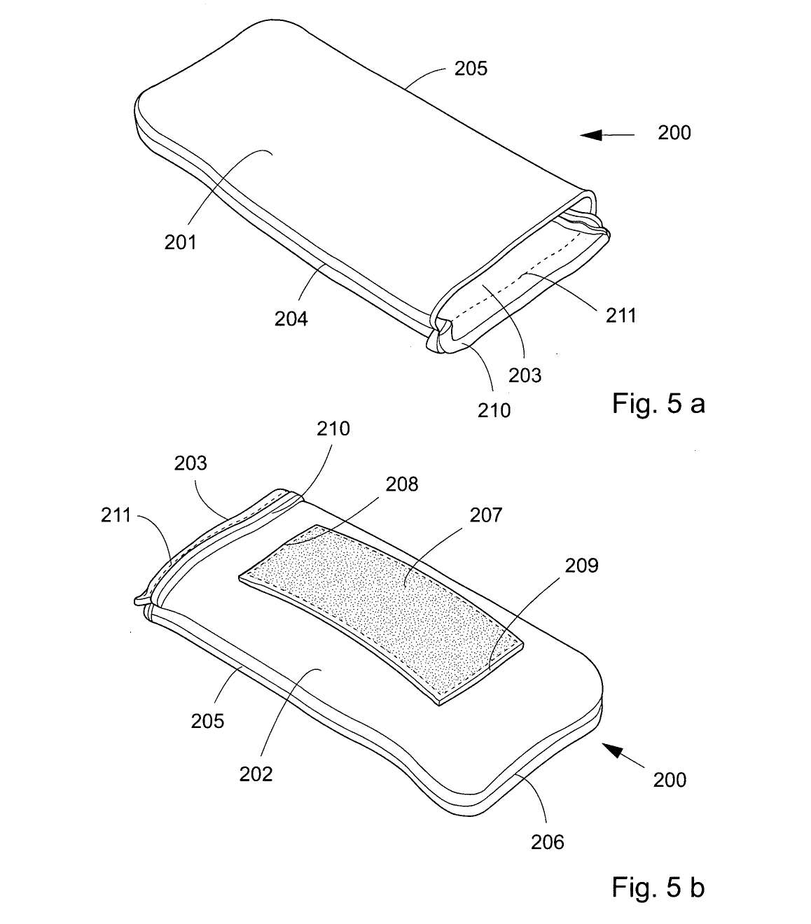

In FIGS. 5a and 5b a pouch 200 for holding and storing a safety knife according to the present invention is shown. The pouch 200 comprises a substantially rectangular front wall 201 and a substantially rectangular rear wall 202 the interior of the pouch 200 being substantially accessible through an opening 203.

The front wall 201 and the rear wall 202 are made of an elastic material such as neoprene, but can be made of any material having similar material characteristics that allows the pouch 200 to follow and adapt to the movement of extracting or pulling the safety knife out of the pouch 200.

Such a movement may as earlier is discussed cause an outer part of the safety knife to be stuck on the hems of the pouch, but by forming the pouch of elastic material the pouch will follow the movement of the safety knife and allow it to be pulled out of the pouch without hinder. This is particularly important when having a safety knife with an angled base arm and extension arm as in the previously shown embodiments of the safety knife.

The front wall 201 and the rear wall 202 are attached to each other by sewing along two sides 204, 205 and a bottom side 206 of the pouch 200. The opening 203 is arranged on the fourth side of the pouch 200. The safety knife can be inserted into the pouch 200 and pulled out of the pouch 200 through the opening 203. The hems (not shown) between the front wall 201 and the rear wall 202 along the sides 204-206 are arranged inside the pouch.

On the outside of the rear wall 202 of the pouch 200 a holding strap 207 is arranged, which is attached to the rear wall 202 by two seams along sides 208, 209 of the strap 207. Between the seams 208, 209 the strap 207 forms a loop, where a belt or a strap (not shown) can be inserted to hold the pouch 200 on the user or on the dress of the user. The strap 207 is preferably provided with a Velcro© type fastener, to which a corresponding Velcro© type fastener of the strap of the safety knife can be attached.

This provides a dual holding function of the safety knife to pouch 200. The safety knife is not only placed in the pouch and held by the design of the pouch, but the strap of the safety knife attached to the end of the safety knife is attached to the Velcro© type fastener on the outside of the pouch 200.

Inside the rear wall 202 a stiffener (not shown) is contained between the rear wall 202 and an inner wall 210, the stiffener having substantially the form of the pouch 200. The stiffener provides the pouch 200 with some rigidity and can be made of a thin sheet of plastics or another semi-rigid material. To contain the stiffener the inner wall 210 is arranged between the front wall 201 and rear wall 202, and sides of the inner wall 210 closed by sewing. One end of the inner wall 210 extends over the rear wall 202 and is attached to the rear wall 202 with a seam 211 (shown in both FIGS. 5a and 5b). The other sides are substantially the same as the side walls 204-206 of the front wall 201 and the rear wall 202, and are sewed by the same sewing as attaching the rear wall 202 to the front wall 201 by the sewing along the sides 204-206 and forming the containment containing the stiffener. The seam 211 closes the containment.

As an alternative to arrange the stiffener inside the pouch 200 the stiffener can be arranged on the outside of the pouch 200, attached to the rear wall 202. The stiffener is attached to the rear wall 202 by sewing along the sides 204-206 and along the fourth side of the rear wall 202. Thus, the stiffener will form the rear part and the holding strap 207 will be arranged on the side of the stiffener not facing rear wall 201 in the same way as it was arranged on the rear wall 202. This alternative embodiment of the pouch 200 reduces the material needed to produce the pouch 200 and simplifies the production of pouch 200.

The invention is not limited to the shown embodiments; several modifications within the scope of the appended claims are possible.

1. A safety knife for cutting lines or straps comprising a handle, a base arm, an extension arm, and a cutting device, wherein said extension arm curves from said base arm to establish an opening between said base arm and said extension arm, wherein said cutting device is arranged in said opening, and wherein the base arm includes an angle with a longitudinal direction of the base arm and a longitudinal direction of the handle.

2. The safety knife according to claim 1, wherein said cutting arrangement comprises two cutting elements arranged in said opening between said base arm and said extension arm, and wherein said two cutting elements from substantially a V-shape.

3. The safety knife according to claim 2, wherein said handle comprises at least one aperture for holding said safety knife.

4. The safety knife according to claim 3, wherein said handle comprises an aperture fro attaching a strap for holding the safety knife.

5. The safety knife according to claim 4, wherein said handle comprises at least one projection for holding said safety knife.

6. The safety knife according to claim 5, further comprising a float, where said float is incorporated in or attached to said handle.

7. The safety knife for cutting lines or straps comprising a handle, a base arm, an extension arm, and a cutting device, wherein said extension arm curves from said base arm to establish an opening between said base arm and said extension, wherein said cutting device is arranged in said opening, and wherein the base arm includes an angle with a longitudinal direction of the base arm and a longitudinal direction of the handle, said cutting arrangement comprises two cutting elements arranged in said opening between said base arm and said extension arm, wherein said two cutting elements form substantially a V-shape, wherein said handle comprises at least one aperture for holding said safety knife, said handle further comprising an aperture for attaching a strap for holding the safety knife, and wherein said handle comprises at least one projection for holding said safety knife.

8. A pouch for a safety knife according to claim 1.

9. The pouch according to claim 8, wherein said pouch is made of an elastic material, and wherein pieces of said elastic material are joined together by sewing to form said pouch having an opening to allow said safety knife to be inserted into and be pulled out of said pouch.

10. The pouch according to claim 8, further comprising a loop arranged on the outside of said pouch and said loop having a fastening device.

11. The pouch according to claim 9, wherein said loop enables the pouch to be attached to another article and wherein said fastening device enables a strap attached to said safety knife to be fastened to the fastening device.

12. The pouch according to claim 10, wherein said fastening device is a Velcro© type fastener.

13. The pouch according to claim 11, wherein said pouch is made of neoprene.

14. A pouch according to claim 12, wherein a stiffener is arranged in a containment of said pouch to provide rigidity to said pouch.

15. A pouch for holding said safety knife, where said pouch is attached to a belt of a user, said pouch is made of an elastic material, and where pieces of said elastic material are joined together by sewing to form said pouch having an opening to allow said safety knife to be inserted into and pulled out of said pouch.

16. The pouch according to claim 15, further comprising a loop arranged on the outside of said pouch and having a fastening device.

17. The pouch according to claim 15, wherein said loop enables the pouch to be attached to another article and where said fastening device enables a strap attached to said safety knife to be fastened to the fastening device.

18. The pouch according to claim 16, wherein said fastening device is a Velcro© type fastener.

19. The pouch according to claim 17, wherein said pouch is made of neoprene.

20. A pouch according to claim 18, wherein a stiffener is arranged in a containment of said pouch to provide rigidity to said pouch.
